(19) United States
(12) Patent Application Publication
(10) Pub. No.: US 2016/0334579 A1
(43) Pub. Date: Nov. 17, 2016

(54) OPTICAL FIBER SPLICE HOUSINGS

(71) Applicant: HALLIBURTON ENERGY SERVICES, INC., Houston, TX (US)

(72) Inventors: Brian Vandellyn Park, Spring, TX (US); Michael Edwin Pollard, Houston, TX (US); Jason Edward Therrien, Cypress, TX (US); Mikko Jaaskelainen, Katy, TX (US)

(21) Appl. No.: 15/112,782

(22) PCT Filed: Apr. 25, 2014
(86) PCT No.: PCT/US14/35438

§ 371 Date: Jul. 20, 2016

(51) Int. Cl. G02B 6/255

(52) U.S. Cl. CPC G02B 6/2558

(57) ABSTRACT

An example device in accordance with an aspect of the present disclosure includes a splice housing body comprising a raceway within which optical fibers can be positioned, at least one port through the splice housing body to which a pressure fitting for optical fiber can be mounted, a base to which the splice housing body may be removably attached, and a port in one of the splice housing body or base for inserting fluid in the splice housing body.

### CROSS REFERENCE TO RELATED APPLICATIONS

This application is related to the following two applications filed the same day as this application, which are both incorporated in this application in their entireties by reference: (1) application Ser. No. ______, for “Hybrid Electrical and Optical Fiber Cable Splice Housings,” Park, et al, inventors, attorney docket no. 61429-897059 and (2) application Ser. No. ______, for “Mounted Downhole Fiber Optics Accessory Carrier Body, Park, et al., inventors, attorney docket no. 61429-896456.

### FIELD OF THE INVENTION

This disclosure relates to fiber optic cables utilized in oil and other wells and other extreme environments and to splices and Y-connections of such cables.

### BACKGROUND

Distributed fiber optic sensors and fiber optic cables are commonly clamped to the tubing or casing during run-in-hole (RIH). The cables are cut at packers and re-spliced once they are fed through the packers, or cut and spliced at sensor locations. In other situations, end terminations or in-line splices are needed. Conventional practice is to take the cables and sensors to a cabin with positive pressure to remove any explosive gases, or to another safe area to prepare and splice the fibers/cables, and then take the finished assembly to the rig-floor and attach the assembly to a pre-manufactured gauge mandrel. The process of moving cables and system components takes time, and rig-time is very expensive. Any reduction in rig-time therefore results in significant savings.

Similarly, space is expensive, and larger casing sizes require larger mandrel sizes for a given tubing size. A splice housing must be designed to survive bottom hole pressures, and the mandrel must be designed to survive bottom hole pressures during stimulation and production.

Many applications use a tubular linear splice housing for the splices, and Y-blocks are attached to the end of the splice housing to break out a fiber for a sensor such as a pressure sensor. The length of the splice and associated machined mandrels may be substantial, which increases cost and complexity. A longer machined mandrel requires a more expensive machine for manufacturing, and the cost is therefore higher.

In existing linear splice configurations, the length of fiber in the splice tray is equivalent to the length of the pressure housing. The fiber is fixed at each end of the splice tray, in some instances with an adhesive like epoxy or room temperature vulcanizing (“RTV”) adhesive. As a result, when the splice housing is lowered in the well bore, it increases in temperature and expands, as does the fiber. However, the coefficient of expansion of the metal is typically an order of magnitude greater than the fiber. As a result, the fiber is stressed in tension, which can affect the optical signals, and the fiber can break.

### BRIEF DESCRIPTION OF THE DRAWINGS

Illustrative embodiments are described in detail below with reference to the following drawing figures:

FIG. 1 is an isometric view of a splice housing lid.

FIG. 2 is an exploded perspective view an alternative embodiment of the splice housing lid shown in FIG. 1 together with an optional simple cover, seals and other attachments.

FIG. 3 is an isometric view of a curved base, oval or oblong raceway fluid-filled fiber optic splice housing assembly with two pressure sensors and a “transparent” splice housing lid.

FIG. 4 is a similar view of the housing assembly and sensors of FIG. 3 with an opaque splice housing lid.

FIG. 5 is an isometric view of a portion of a solid, machined mandrel with the fiber optic splice housing and pressure sensors of FIG. 2 shown attached to a flat surface of the mandrel.

FIG. 6 is an isometric view of the mandrel shown in FIG. 5 without the splice housing or sensors attached.

FIG. 7 is an isometric view of a modular mandrel assembly with collars securing a splice housing and sensor cover on a section or length of round casing.

FIG. 8 is an enlarged view of the splice and sensor housing shown in FIG. 7 with a transparent splice housing and sensor cover.

### DETAILED DESCRIPTION

The subject matter of embodiments of this patent is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

At high temperatures, current linear splice housings can expand in length much more than the fiber due to differences in the thermal expansion of metal and glass. This creates stress in the fiber that can affect the optical properties of the signal, or in some cases, cause the fiber to break. Elimination of stress and breakage and increased splice reliability are key to the successful operation of down hole fiber telemetry.

A fiber optic splice housing in accordance with this disclosure may be used down hole for optical fiber splicing to connect fiber optic sensors and devices to optical fiber in FIMT (fiber in metal tube) or other optical fiber. Typical sensors that may be connected with these devices and methods include pressure sensors, flow sensors and the like. The splice housing assemblies of this disclosure can house, among others, end splices, through splices, single gauges, gauges and through splices and two gauges and through splices.

The splice chamber of this disclosure may be filled with fluid to prevent gel from the FIMTs travelling into the housing, which can also cause fiber breakage because the gel sometimes pulls fiber into the splice housing.

Incorporation of a Y-splitter in the same splice housing eliminates multiple connections and the need for a secondary housing. This simplifies and shortens the required structures, which reduces the length of the mandrel to which it is mounted.

Other embodiments provide a modular mandrel and associated hardware to simplify and shorten the design, to minimize cost, to minimize rig time, to make a slimmer overall package than existing pressure gauge mandrels and splice hardware.

The splicing techniques and apparatus described here can make use of a zone-rated fiber optic splice kit and techniques. Because this apparatus can hold a sufficient length of fiber in loops, there is sufficient length to get the splice joint in the raceway of this apparatus (described below). In order to use a zone rated splicer with a linear splice housing, the linear splice housing would have to be much longer than it is currently, necessitating a longer mandrel to house it.

The splice housings of this disclosure utilize versatile splice housing bodies or “lids” usable with a variety of bases, mandrels and other structures to form a splice housing assembly within which splices and other structures are positioned and to which sensors and other devices may be attached. The housing assemblies of this disclosure may be used for end termination, pass through splices, gauge mounting and combinations of these. Splice housing assemblies could also be structured for the housing body to be formed in a mandrel or other base for use with a simpler cover. Such a structure may, however, be more difficult or expensive to manufacture and may forgo the versatility of incorporating the housing body cavity within the lid as described and illustrated here.

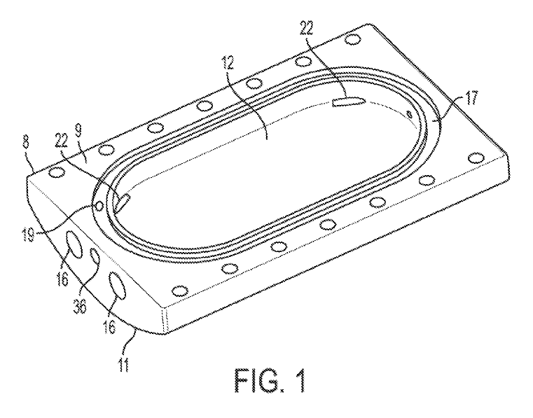

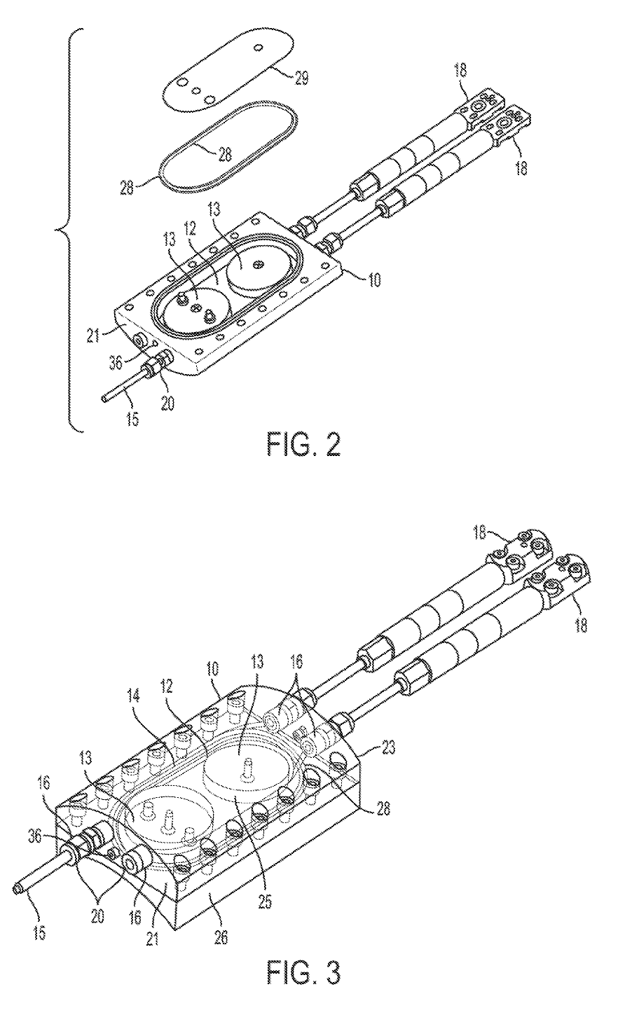

The figures depict two exemplary splice housing lids. A first embodiment is shown as lid 8 in FIG. 1. A second embodiment is depicted as lid 10 in FIGS. 2, 3, 4, 5, 7 and 8. Numerous other lid configurations in accordance with this disclosure are possible.

As shown in FIG. 1, splice housing lid 8 has a flat mounting surface 9, a curved outer surface 11, and lid 8 defines an oval or oblong “raceway” 12 within which fiber optic cable, splices, connections to sensors and other similar structures may be housed and protected when lid 8 is attached, typically with machine screws, to a base to form a splice housing assembly. Raceway 12 may have alternative shapes, including, without limitation, round and oval or oblong with different proportions than the exemplary proportions of those shown in the drawings.

Lid 10 (shown in FIGS. 2, 3, 4, 5, 7 and 8) likewise utilizes an oblong raceway 12 but also includes two disks 13 around which cable can be wound. An optional, simple plate-like cover (an example of which is shown as cover 29 in FIG. 2) may be attached to the lid 8 or 10 to retain fiber cables within the lid until the lid and simple cover can be attached to a base.

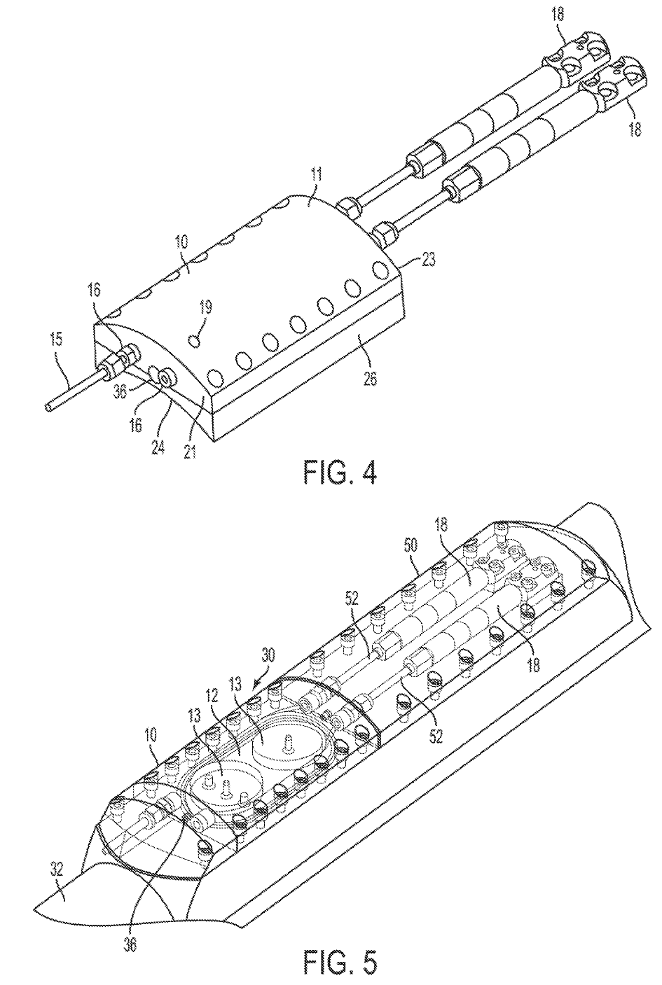

When attached to a base such as base 26 shown in FIGS. 3 and 4, lids 8 and 10 provide an oval or oblong, pressure tight, fluid-fillable enclosure for fiber optic cable 14 that is part of FIMT 15. The FIMT 15 that runs to the surface contains multiple fibers that can be Multi-mode or Single-mode or a combination of both. As depicted in FIGS. 2, 3 and 4, the FIMT 15 is connected to the lid 10 using pressure or compression fittings 20 in one end 21 of the lid 10. The compression fittings 20 lead fiber 14 through ports 16 in lid 10 (as well as lid 8), and the fibers 14 are laid in the raceway 12 inside the lid 10. The inside-the-lid openings 22 of ports 16 through which cables 14 enter the raceway 12 are most clearly visible in FIG. 1. At the opposite end 23 of lid 10, gauges 18 are connected to the lid 10 through ports 16 using compression fittings 20. Fibers 14 from the gauges 18 likewise pass into the lid 10 and are laid in the raceway 12.

As is depicted in FIG. 1 showing lid 8, raceway 12 need not contain additional structures. However, positioning of fiber cables 14 in the raceway 12 can be facilitated by one or more structures within the raceway such as pins or other structures around which the fiber cables 14 are loosely wound to facilitate placing and retaining the fibers within the splice housing as desired. Similar “loose winding” or loose loops of fiber may be positioned in the fiber housings of this disclosure without use of pins or other structures within lids 8, 10 or other embodiments of this disclosure. This loose winding also allows for relative expansion between fiber and the raceway 12 to compensate for thermal expansion, in addition to providing room for significant lengths of additional fiber, reducing stress on the fiber and accommodating subsequent changes if needed.

As examples, winding structures may be one, two (or more) cable wind cylinders or disks 13 within lid 10. These disks 13 may be integrally formed with the lid 10 or separately formed and secured to the lid by screws, bolts, pins, adhesives or other appropriate fasteners. As but one example of alternatives to full disks 13, one half-disk having a D-shape may be positioned at each end of the oval raceway 12 with each half-disk curved surface facing one of the curved ends of the raceway 12.

In addition to the cable management functions described below, disks 13 may provide support for the housing by contact between the disks 13 and the base structure to which the lid 10 is attached when assembled with a base such as base 26.

Optional disks 13, if used, may have either a straight or a sloping peripheral edge or wall 25. With a sloping peripheral wall 25, disks 13 are not cylindrical sections but are truncated conical sections with the smaller diameter face against the floor of the raceway 12 in lid 10. Wall 25 of each disk 13 may alternatively have a more complex shape. For instance, wall 25 may be concave, curving from top to bottom as well as around the disk 13. It is desirable for cable 14 to be loosely positioned within a raceway 12. However, disks 13 with an inward-sloping peripheral wall 25 so that the bottom of the disk 13 in the bottom of the raceway 12 is smaller in diameter than the portion at the top of disk 13 may facilitate retention of the cables 14 in the raceway 12 when the lid 10 is not in place on a base, because a loop of cable 14 even relatively loosely wound around such a sloping-wall disk 13 must expand in order to slip off of the disk 13. T-slots or other cable management structures may also be usable in lid 8 or 10 if desired.

Other numbers and locations of ports 16 and compression fittings 20 than those depicted in the drawings may be used to provide appropriate access consistent with the needs of a particular installation. Because fibers 14 are laid loosely in or pushed into the ends of the raceway 12 and are not wrapped tightly around or attached to structure, different lengths of fibers 14 can be accommodated, there is “extra” fiber 14 with which to splice or to which other fiber can be attached, and there is significantly reduced likelihood the fiber 14 will break.

Different combinations of gauges, pass through FIMTs, end terminations for DTS (distributed temperature sensing) or DAS (distributed acoustic sensing) fiber, or in-line splices can all be accommodated. By having multiple inlets and outlets in the splice housing assemblies of lid 8 or 10, the need for a secondary Y splitter housing is eliminated. When a port 16 is not used, it may be plugged. In an exemplary situation, a splice assembly of this disclosure may accommodate a DTS termination, a DAS termination, an inline splice to a pass-through FIMT to connect to sensors lower down the production string, and to an internal pressure gauge and an external pressure gauge. Thus, one FIMT 15 to the surface may carry six or more fibers.

Strain gauges may also be placed within the raceway 12 of the lid 8 or 10.

The fibers 14 within lid 8 or 10 and other lids and housings described herein can be joined by normal splicing techniques using fusion splicers and recoating tools, or splice protectors, or the fibers can be joined using miniature fiber connectors or other means. The raceway 12 provides space for connectors if connectors are used, which linear splice housings may not provide. The raceway 12 also accommodates “crossover” of fiber 14 so that a fiber 14 can reverse direction, although “crossover” of fiber 14 to accomplish a fiber turnaround may also be done in a lid 8 not having disks 13. The fiber lies loosely in the channel or raceway 12 so that the metal lid 8 or 10 can expand and contract as temperature fluctuates without forcing the fibers 14 in the lid 10 into stress or shear.

Prior to assembly of the lid 8 or 10 and base 26, the fibers 14 are held in place within the lid 8 or 10 by the sides and ends of the raceway 12 and by optional disks such as disks 13 in lid 10 and by an optional cover 29 shown in FIG. 2 that may rest on disks 13.

After assembly of lid 8 or 10 and base 26 or another appropriate base structure, the cavity in lid 8 or 10 provided by raceway 12 is closed by the base 26 that may utilize guide pins (not shown) to facilitate alignment and that may be secured to the lid 8 or 10 with screws, bolts or other appropriate fasteners or fastener structures. In light of possible internal pressurization of the lid 8 or 10 and base 26 assembly, and the external pressure environments within which the assembly may be used, an effective seal between the lid 8 or 10 and base 26 is necessary. Such a seal can be achieved by providing a groove 17 (best seen in FIG. 1) surrounding the raceway 12 in one of (a) the lid 8 or 10, or (b) base 26, within which groove 17 one or two C-seals 28 or other sealing material may be placed. Assembly of the lid 8 or 10 and base 26 will then compress the C-seal or rings or other seal between the two lid and base components while the groove keeps the seal(s) properly positioned. Alternatively, two or more pairs of grooves, such as concentric grooves, may be used in one of the lid 8 or 10 and base 26, together, for instance with C-rings of appropriate resilient sealing material.

A pressure test port 19, which passes through lid 8 or 10 into groove 17 (and is visible in FIGS. 1 and 4) can provide the ability to test the sealing capability of the C-seals after assembly.

Fill port 36 (visible in FIGS. 1, 2, 3, 4 and 5) enables the raceway 12 cavity in lid 8 or 10 (when a lid is assembled with a base 26 or other appropriate base) to be filled with appropriate fluid that optionally may be pressurized. Such pressurization prevents gel inside the FIMT from travelling into the splice housing assembly of lid 8 or 10 and base 26, which can cause the fiber 14 to break inside the FIMT. A vent port can also be included if desired, through which gas can vent when the splice housing assembly is filled or pressurized with a fluid. Alternatively, filling and venting can be performed alternatively through the same port.

As is indicated by the shape of the bottom of base 26 shown in FIGS. 3 and 4, the bottom 24 of base 26 may be curved, preferably in the shape of a segment of a cylinder matching the surface of well casing with which the splice housing assembly of lid 10 and base 26 is used. This permits the lid 10/base 26 splice housing assembly to be strapped or clamped to such well casing (not shown) with the base 26 in contact with the casing and facilitates secure attachment.

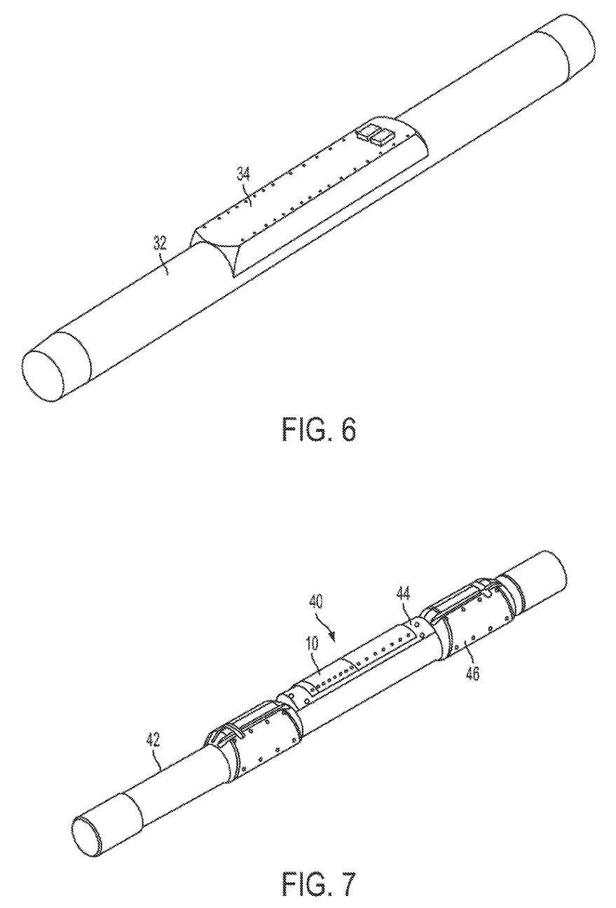

FIG. 5 shows an alternative splice housing assembly 30 utilizing a machined mandrel 32 (shown separately in FIG. 6). A flat surface 34 of mandrel 32 (see FIG. 6) serves as a base to which a lid 8 or 10 may be attached. Like splice housing assemblies of lids 8 or 10 and base 26, a splice housing assembly of lid 8 or 10 and mandrel 32 houses all the splices, and the mandrel 32 and sensor cover 50 hold sensors or gauges 18 and sensor cables 52.

Unlike conventional mandrels that use a linear splice housing and are about nine feet long, or longer if a Y splice and full length gauges were installed, the mandrel 32 may be much shorter and simpler to produce. The assembly of the mandrel 32 and other components to provide housing assembly 30 during RIH (run in hole) is significantly easier than is the case for a conventional linear splice housing, and raceway 12 provides significant flexibility. If the fibers 14 can be spliced on the rig-floor using a zone rated splicer even more time will be saved.

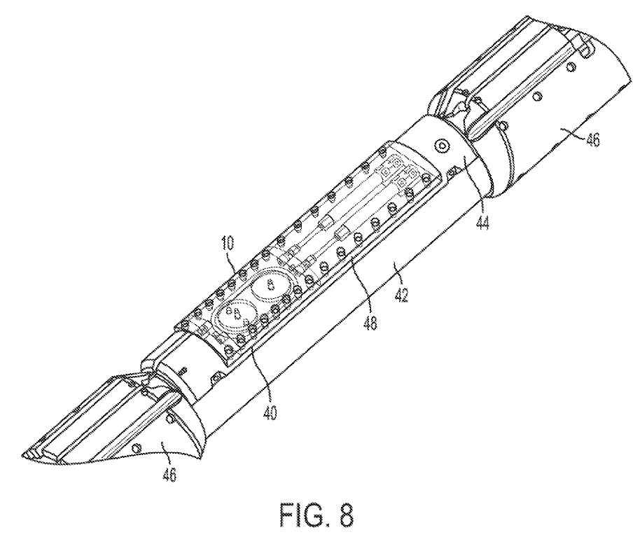

In another alternative embodiment depicted in FIGS. 7 and 8, a modular splice housing assembly 40 may include a lid 10, sensor base 48 and associated components secured to a carrier 44 that serves as a base and is in turn secured to a cylindrical casing 42 with two collars or end rings 46. The housing assembly 40 holds all the cable 14 splices, and all of the cables, including sensor cables.

Different arrangements of the components depicted in the drawings or described above, as well as components and steps not shown or described, are possible. Similarly, some features and subcombinations are useful and may be employed without reference to other features and subcombinations. Embodiments of the disclosure have been described for illustrative and not restrictive purposes, and alternative embodiments will become apparent to readers of this patent. Accordingly, the present disclosure is not limited to the embodiments described above or depicted in the drawings, and various embodiments and modifications can be made without departing from the scope of the claims below.

For instance, the raceway 12 within the lids 8 and 10 may be other appropriate shapes in addition to the oval or oblong shapes depicted in the Figures. Such raceways may be round and egg-shaped, among other alternatives providing the capacity to receive differing lengths of optical fiber and fiber splices and protect such fiber and splices from damage throughout the time the optical fiber needs to be in use. Additionally, such a raceway cavity may be machined directly in a mandrel and then covered with an appropriate lid or cover. Sensors may or may not be used with or mounted to the splice housing structures and different sensors than the types mentioned herein may be used.

That which is claimed is:

1. A cable splice housing assembly for use in a well, comprising:
(a) a splice housing body comprising a raceway within which optical fibers can be positioned,
(b) at least one port through the splice housing body to which a pressure fitting for optical fiber can be mounted,
(c) a base to which the splice housing body may be removably attached and
(d) a port in one of the splice housing body or base for inserting fluid in the splice housing body.

2. The cable splice housing assembly of claim 1, wherein the base is an integral part of a mandrel.

3. The cable splice housing assembly of claim 1, wherein the raceway is oblong or oval.

4. The cable splice housing assembly of claim 1 wherein the splice housing body has surface having the same shape as a mandrel surface to which the splice housing body may be attached.

5. The cable splice housing assembly of claim 4, wherein the mandrel contact surface is curved.

6. The cable splice housing assembly of claim 4, wherein the mandrel contact surface is flat.

7. The cable splice housing assembly of claim 6, wherein the mandrel serves as a base for the splice housing body when the splice housing body is secured to the mandrel.

8. The cable splice housing assembly of claim 7, wherein the splice housing body is secured to the mandrel with threaded fasteners that pass through the splice housing body and into the mandrel.

9. The cable splice housing assembly of claim 1, further comprising a plurality of ports at which compression fittings may be attached for introducing optical fiber cable into the splice housing body.

10. The cable splice housing assembly of claim 1, further comprising at least one port to which at least one sensor may be attached.

11. The cable splice housing assembly of claim 1, further comprising a cover positionable between the splice housing body and the base.

12. The cable splice housing assembly of claim 1, further comprising a seal-receiving groove in one of the splice housing body or the base.

13. The cable splice housing assembly of claim 12, further comprising two C-seals in the groove.

14. The cable splice housing assembly of claim 11, further comprising a plurality of threaded fasteners for attachment of the base to the splice housing body.

15. The cable splice housing assembly of claim 1, further comprising collar engaging structure on the splice housing base and at least one collar for securing the splice housing body and base to a casing.

16. A cable splice housing assembly, comprising:
(a) a splice housing body:
(i) comprising a generally flat and generally oval or oblong cavity for receiving cable and cable splices,
(ii) penetrated by:
(1) at least two cable or sensor ports at which compression fittings can be attached and
(2) one fill port, and
(iii) having a seal-receiving groove around the cavity,
(b) a base for the splice housing body, wherein the base is penetrated by at least two holes through which threaded fasteners may pass into the splice housing body for securing the base to the splice housing body.

17. The cable splice housing assembly of claim 16, further comprising at least one port in the splice housing body to which a compression fitting may be attached for passage of a sensor cable into the cable splice housing assembly.

18. The cable splice housing assembly of claim 16, further comprising at least one collar for securing the cable splice housing assembly to a mandrel.

19. The cable splice housing assembly of claim 16, further comprising a holder for sensors mounted adjacent to the cable splice housing body.

20. A modular cable splice housing assembly for use in a well, comprising:
(a) a splice housing assembly comprising a raceway within which optical fibers can be positioned, and
(b) at least one end ring for securing the splice housing assembly to well casing.
